(19) United States
(12) Patent Application Publication
(10) Pub. No.: US 2003/0190582 A1
(43) Pub. Date: Oct. 9, 2003

(54) Dental facility having changeable dental tools

(76) Inventor: Hsih Chin Lou, Chong Ho City (TW)

Correspondence Address: Hsih Chin Lou, P.O. Box 10-69,, Chong Ho, Taipei, 235, TW

(21) Appl. No.: 10/122,249

(22) Filed: Apr. 8, 2002

(51) Int. Cl. A61C 1/08

(52) U.S. Cl. 433/126; 433/133

(57) ABSTRACT

A dental facility includes a latch disposed in a coupler and having a tongue extendible outward of the coupler, a dental tool member having a barrel engageable onto the coupler, and a spring for biasing the tongue of the latch to engage with the barrel and to detachably secure the dental tool member to the coupler. The dental tool member may be detached from the coupler for being discarded or changed with the other one after use, and for preventing both the patients and the dentists from being contaminated or infected by the dental tool member.

### BACKGROUND OF THE INVENTION

1. Field of the Invention

The present invention relates to a dental facility, and more particularly to a dental facility having changeable dental tool members.

2. Description of the Prior Art

Typical dental facilities comprise such as the dental burs, which includes a bur head or bur tool attached to one end of a handle, for engaging into the mouths of the users and for working onto the teeth. The typical dental facilities may further include a spraying device having a sprayer head attached to one end of a handle, also for engaging into and for spraying water into the mouths of the users, and/or for working onto the teeth of the users. The dental tool members, such as the bur heads or bur tools, or the sprayer heads, are solidly secured to the handle and may not be disengaged from the handle, such that the dental tool members may only be flushed or cleaned with water or detergent after every working or operation.

However, AIDS has become a serious problem to both the dentists and the patients, because the AIDS viruses may be contaminated or infected via the dental tool members that have not been completely cleaned, and that may not be fully and completely cleaned.

The present invention has arisen to mitigate and/or obviate the afore-described disadvantages of the conventional dental facilities.

### SUMMARY OF THE INVENTION

The primary objective of the present invention is to provide a dental facility including a dental tool member that may be easily disengaged or removed from the handle, and that may be discarded after use, and that may be quickly changed with the other ones after use.

In accordance with one aspect of the invention, there is provided a dental facility comprising a coupler including an upper portion, a latch disposed in the coupler, and including a tongue extendible outward of the coupler, a dental tool member including a barrel engageable onto the upper portion of the coupler, and means for biasing the tongue of the latch to engage with the barrel and to detachably secure the dental tool member to the coupler. The dental tool member is allowed to be detached from the coupler for being changed with the other one after use, and for preventing both the patients and the dentists from being contaminated or infected with various viruses by the dental tool member.

The coupler includes a shank disposed in the upper portion of the coupler and having an upper portion extended upward beyond the coupler, the shank includes a channel formed therein for receiving the latch.

The shank includes an aperture formed therein and communicating with the channel of the shank, and a rod engaged through the aperture of the shank and engaged through the latch for pivotally securing the latch to the shank.

The shank includes a cavity formed therein, the biasing means includes a spring received in the cavity of the shank and engaged with the latch for biasing the tongue of the latch to engage with the barrel of the dental tool member.

The barrel includes a hole formed therein. A device may further be provided for disengaging the tongue of the latch from the barrel of the dental tool member, and includes a knob slidably engaged in the hole of the barrel and engaged with the latch for depressing the latch against the biasing means and for disengaging the tongue of the latch from the barrel of the dental tool member.

The knob includes an inner end located with the barrel and having an enlarged head provided thereon for engaging with the barrel and for preventing the knob from being disengaged from the barrel.

A duct is further provided and secured to the coupler, and a handle is further provided and attached to the duct. The duct includes a bent upper portion secured to the lower portion of the coupler.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a dental facility in accordance with the present invention;

FIG. 2 is a cross sectional view taken along lines 2-2 of FIG. 1;

FIG. 3 is a cross sectional and exploded view of the dental facility; and

FIG. 4 is an end view illustrating the coupler of the dental facility for quickly coupling the dental tool member.

### DETAILED DESCRIPTION OF THE PREFERRED EMBODIMENT

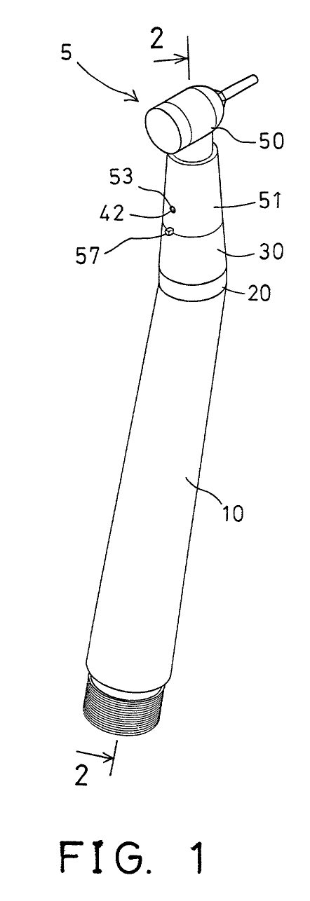

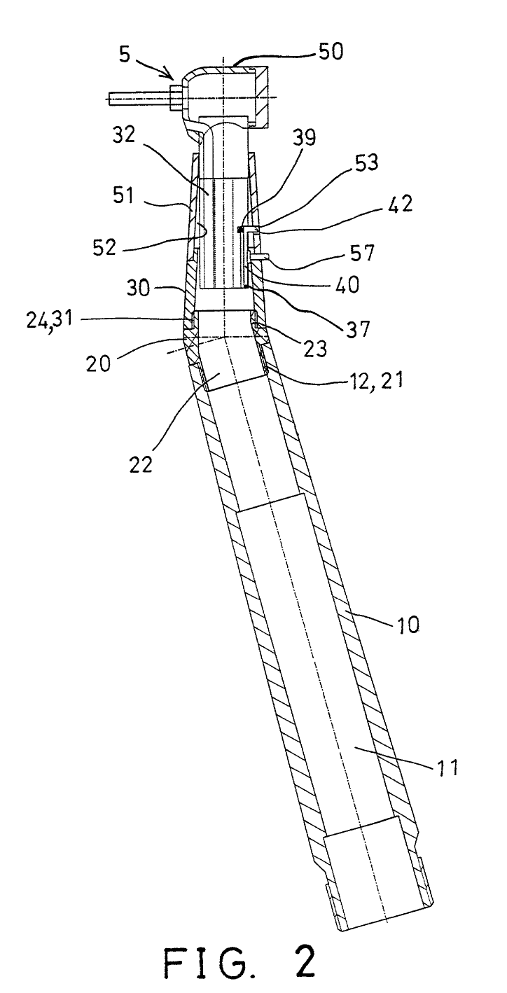

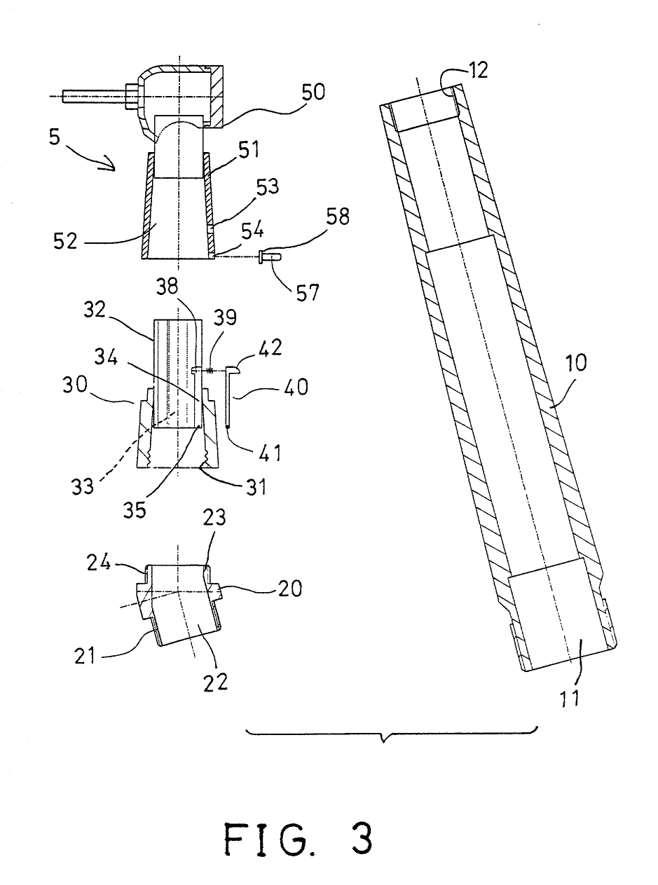

Referring to the drawings, and initially to FIGS. 1-3, a dental facility in accordance with the present invention comprises a handle 10 including a bore 11 formed therein and including one end, such as the lower end thereof for coupling to the water and/or medicine reservoir, for receiving the water and/or the medicine therefrom. The handle 10 includes an inner thread 12 formed in the other end thereof, such as the upper end thereof.

A duct 20 includes an outer thread 21 formed or provided on the outer peripheral portion of the lower portion thereof for threading with the inner thread 12 of the handle 10, and for coupling the duct 20 to the handle 10. The duct 20 includes a bore 22 formed therein for communicating with the bore 11 of the handle 10 and for receiving the water and/or the medicine from the handle 10. The duct 20 includes a bent portion 23 formed or provided on the upper portion thereof and having an outer thread 24 formed or provided on the outer peripheral portion thereof.

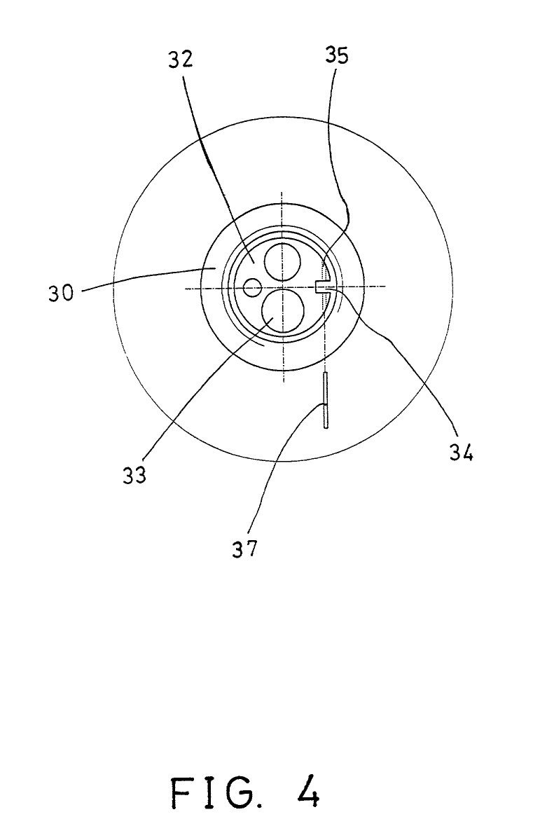

A coupler 30 includes an inner thread 31 formed or provided in the lower portion thereof for threading with the outer thread 24 of the duct 20, and for attaching the coupler 30 to the duct 20. Alternatively, the coupler 30 may also be directly secured to the handle 10, instead of to the duct 20. The coupler 30 includes a shank 32 secured in the upper portion thereof with such as fasteners, or adhesive materials, or by welding processes. The shank 32 has an upper portion partially extended upward and outward beyond the coupler 30, and includes one or more passages 33 formed therein (FIG. 4) for communicating with the bores 11, 22 of the handle 10 and the duct 20 and for receiving the water and/or the medicine from the duct 20 and the handle 10.

The coupler 30 includes a channel 34 formed therein, such as formed in the shank 32, and an aperture 35 formed in the lower portion of the shank 32 and communicating with the lower portion of the channel 34 thereof for receiving a rod 37 therein, and a cavity 38 formed in the shank 32 and communicating with the upper portion of the channel 34 of the coupler 30 for receiving a spring 39 therein.

A latch 40 is received in the channel 34 of the coupler 30, and includes an orifice 41 formed therein, such as formed in the lower portion thereof for receiving the rod 37 and for rotatably securing the lower portion of the latch 40 to the shank 32 or to the coupler 30. The latch 40 includes a tongue 42 provided or bent or formed on the upper portion thereof and extended away from the shank 32 or the coupler 30. The spring 39 may engage with the latch 40 and thus may bias the tongue 42 of the latch 40 outward or away from the shank 32 or the coupler 30.

A dental tool member 5, such as a bur head 50, provided on the upper portion of a barrel 51 for engaging into the mouths of the uses and for working onto the teeth of the users. The barrel 51 includes a bore 52 formed therein for receiving the upper portion of the shank 32 or of the coupler 30, and includes an opening 53 formed therein for selectively or detachably receiving the tongue 42 of the latch 40 and for detachably securing the barrel 51 and the bur head 50 of the dental tool member 5 to the coupler 30.

It is to be noted that the tongue 42 of the latch 40 may be moved inward of the channel 34 of the shank 32 or of the coupler 30 when the upper portion of the shank 32 or of the coupler 30 is engaged into the bore 52 of the barrel 51, for allowing the tongue 42 of the latch 40 to be biased and engaged into the opening 53 of the barrel 51 when the tongue 42 of the latch 40 is aligned with the opening 53 of the barrel 51, such that the dental tool member 5 may be easily and quickly secured onto the coupler 30 with the latch 40.

The barrel 51 further includes a hole 54 formed therein, such as located below the opening 53 of the barrel 51. A button or a knob 57 is slidably received in the hole 54 of the barrel 51, and includes an enlarged head 58 formed on one end thereof, such as the inner end thereof, and received in the barrel 51, for preventing the knob 57 from being disengaged from the barrel 51. The inner end of the knob 57 is engaged with the latch 40 for depressing the latch 40 against the spring 39, and for disengaging the tongue 42 of the latch 40 from the barrel 51, and for allowing the dental tool member 5 to be easily and quickly disengaged from the coupler 30, and for allowing the dental tool member 5 to be easily and quickly discarded or replaced with the other ones.

After each time of use or operation, or after the dental tool member 5 has been engaged into the mouth of a patient, the dental tool member 5 may be easily and quickly disengaged from the coupler 30, and may thus be discarded after each or every use. The other dental tool members 5 may then be easily and quickly secured or attached onto the coupler 30 for engaging with or for working onto the teeth of the other users. The patients thus will not be infected with the AIDS or the other viruses by the dental tool member 5.

Accordingly, the dental facility in accordance with the present invention includes a dental tool member that may be easily disengaged or removed from the handle, and that may be discarded after use, and that may be quickly changed with the other ones after use.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dental facility comprising:
a coupler including an upper portion,
a latch disposed in said coupler, and including a tongue extendible outward of said coupler,
a dental tool member including a barrel engageable onto said upper portion of said coupler, and
means for biasing said tongue of said latch to engage with said barrel and to detachably secure said dental tool member to said coupler,
said dental tool member being allowed to be detached from said coupler for being changed with the other one after use.

2. The dental facility according to claim 1, wherein said coupler includes a shank disposed in said upper portion of said coupler and having an upper portion extended upward beyond said coupler, said shank includes a channel formed therein for receiving said latch.

3. The dental facility according to claim 2, wherein said shank includes an aperture formed therein and communicating with said channel of said shank, and a rod engaged through said aperture of said shank and engaged through said latch for pivotally securing said latch to said shank.

4. The dental facility according to claim 2, wherein said shank includes a cavity formed therein, said biasing means includes a spring received in said cavity of said shank and engaged with said latch for biasing said tongue of said latch to engage with said barrel of said dental tool member.

5. The dental facility according to claim 1 further comprising means for disengaging said tongue of said latch from said barrel of said dental tool member.

6. The dental facility according to claim 5, wherein said barrel includes a hole formed therein, said disengaging means includes a knob slidably engaged in said hole of said barrel and engaged with said latch for depressing said latch against said biasing means and for disengaging said tongue of said latch from said barrel of said dental tool member.

7. The dental facility according to claim 6, wherein said knob includes an inner end located with said barrel and having an enlarged head provided thereon for engaging with said barrel and for preventing said knob from being disengaged from said barrel.

8. The dental facility according to claim 1 further comprising a duct secured to said coupler, and a handle attached to said duct.

9. The dental facility according to claim 8, wherein said coupler includes a lower portion, said duct includes a bent upper portion secured to said lower portion of said coupler.
